(19) United States
(12) Patent Application Publication
(10) Pub. No.: US 2025/0137690 A1
(43) Pub. Date: May 1, 2025

(54) Flow Valve and Water Heater

(71) Applicant: Wuhu Midea Smart Kitchen Appliance Manufacturing Co., Ltd., Wuhu (CN)

(72) Inventors: Pitian LI, Wuhu (CN); Long LI, Wuhu (CN); Sensen XIN, Wuhu (CN)

(21) Appl. No.: 19/004,012

(22) Filed: Dec. 27, 2024

Related U.S. Application Data
(63) Continuation of application No. PCT/CN2024/101711, filed on Jun. 26, 2024.

(30) Foreign Application Priority Data
Sep. 13, 2023 (CN) 202311184316.6

(51) Int. Cl. F24H 15/325; F24H 1/14; F24H 9/13; F24H 9/20

(52) U.S. Cl. CPC F24H 15/325; F24H 1/145; F24H 9/139; F24H 9/2035

(57) ABSTRACT

A flow valve includes: a first valve body provided with a first water inlet, a first water outlet, and a bypass port, a second valve body detachably connected to the first valve body and provided with a second water inlet, a second water outlet, and a water passage and a controller provided at the first valve body. A first flow channel is communicated with the first water inlet and the first water outlet, and a bypass flow channel is communicated with the first flow channel and the bypass port. A second flow channel is communicated with the second water inlet and the second water outlet, and the bypass port communicated with the second flow channel via the water passage. The controller is configured to control a water flow rate of the bypass flow channel.

### CROSS-REFERENCE TO RELATED APPLICATIONS

This application is a continuation application of International Application No. PCT/CN2024/101711, filed on Jun. 26, 2024, which claims priority to Chinese Patent Application No. 202311184316.6, filed on Sep. 13, 2023. The disclosures of the above-mentioned applications are incorporated herein by reference in their entireties.

### TECHNICAL FIELD

The present application relates to the technical field of waterway control, and in particular to a flow valve and a water heater.

### BACKGROUND

Most conventional water heaters have a bypass tube connected between the cold water inlet tube and the hot water outlet tube of the heat exchanger. The cold water in the cold water inlet tube is transported to the hot water outlet tube through the bypass tube to mix with the hot water in the hot water outlet tube to achieve the bypass water mixing function. Water heaters with such a bypass structure, especially water heaters with coilless heat exchangers, may have problems such as constant temperature difference between start and stop, high vaporization noise, and low thermal efficiency.

### SUMMARY

A flow valve, aiming at being well suited for the tube system of a water heater is disclosed, so that the water heater has a bypass water mixing function, and can effectively improve problems such as start-stop constant temperature difference, high vaporization noise, and low thermal efficiency; and the flow valve has low processing and manufacturing difficulty and is suitable for mass processing and production.

A flow valve, provided inside a water heater is disclosed. The flow valve includes: a first valve body provided with a first water inlet, a first water outlet, and a bypass port; a second valve body is detachably connected to the first valve body and provided with a second water inlet, a second water outlet, and a water passage; and a controller provided at the first valve body.

The flow valve of the present application includes a first valve body, a second valve body and a controller provided at the first valve body. The first valve body and the second valve body are assembled to form the valve body of the flow valve, and the valve body is constructed with a first flow channel communicating the first water inlet and the first water outlet, a second flow channel communicating the second water inlet and the second water outlet, and a bypass flow channel communicating the first flow channel and the second flow channel. The controller is used to control the water flow rate of the bypass flow channel. When the flow valve is applied to a water heater, the valve body is simultaneously connected in series to the cold water inlet tube and the hot water outlet tube of the heat exchanger, the first flow channel can be used as an inlet flow channel connected to the cold water inlet tube, the second flow channel can be used as an outlet flow channel connected to the hot water outlet tube, and the cold water in the first flow channel can be transported to the second flow channel through the bypass flow channel. The flow valve can be well applied to the piping system of the water heater, so that the water heater has a bypass water mixing function. The controller is used to be electrically connected to the control system of the water heater. The control system sends corresponding control instructions to the controller according to the working state of the water heater, and then the water flow rate of the bypass flow channel can be controlled through the controller. The bypass mixed water volume of the water heater can be adjusted according to the actual working conditions, which can effectively improve the problems of the start-stop constant temperature difference, high vaporization noise, low thermal efficiency, etc., of the conventional water heater. The valve body of the flow valve includes a first valve body and a second valve body that are separately provided. When manufacturing the valve body, the first valve body and the second valve body can be formed separately, and then the first valve body and the second valve body can be assembled. Compared with the valve body of the integrated structure, the structure of the first valve body and the second valve body is simple, which is easy to process and form, and can reduce the difficulty of manufacturing the valve body, so that the manufacturing difficulty of the flow valve is low and suitable for mass production.

### BRIEF DESCRIPTION OF THE DRAWINGS

In order to more clearly illustrate the technical solutions in the embodiments of the present application or in the related art, drawings used in the embodiments or in the related art will be briefly described below. Obviously, the drawings in the following description are only some embodiments of the present application. It will be apparent to those skilled in the art that other figures can be obtained according to the structures shown in the drawings without creative work.

FIG. 1 is a schematic structural diagram of a flow valve according to some embodiments of the present application.

FIG. 2 is a front view of the flow valve in FIG. 1.

FIG. 3 is a cross-sectional schematic diagram of the flow valve in FIG. 1.

FIG. 4 is a schematic diagram of an exploded structure of the flow valve in FIG. 1.

FIG. 5 is a schematic structural diagram of a water heater according to some embodiments of the present application.

FIG. 6 is a schematic diagram of an assembly structure of the flow valve and the heat exchanger in FIG. 5.

Description of reference signs:

| Reference | | Reference | |
|---|---|---|---|
| signs | Name | signs | Name |
| 1000 | water heater | 132 | the first water outlet |
| 100 | flow valve | 133 | the second water outlet |
| 10 | valve body | 134 | seal groove |
| 10a | first valve body | 135 | card slot |
| 10b | second valve body | 14 | installation base |
| 11 | first tube body | 141 | sink |
| 101a | first water inlet | 15 | seal plug |
| 101b | first water outlet | 16 | seal ring |
| 101c | bypass port | 17 | insert sleeve |
| 101d | external port | 171 | insert hole |
| 111 | first flow channel | 20 | controller |
| 112 | extension part | 21 | driver |
| 12 | second tube body | 211 | motor |
| 102a | second water inlet | 212 | push rod |
| 102b | second water outlet | 22 | seal |
| 121 | second flow channel | 200 | heat exchanger |
| 122 | water passage | 210 | cold water inlet tube |
| 13 | bypass tube | 220 | hot water outlet tube |
| 131 | bypass flow channel | 300 | burner |
| 1311 | first bypass section | 400 | fan |
| 1312 | second bypass section | | |

The realization of the purposes, functional features and advantages of the present application will be further explained with reference to the accompanying drawings in combination with the embodiments.

### DETAILED DESCRIPTION OF THE EMBODIMENTS

The technical solutions in the embodiments of the present application will be clearly and completely described below with reference to the drawings in the embodiments of the present application. Obviously, the described embodiments are only a part of the embodiments of the present application and not all of them. Based on the embodiments in the present application, all other embodiments obtained by those skilled in the art without creative efforts fall within the protection scope of the present application.

It should be noted that any directional instructions in the embodiments of the present application (such as up, down, left, right, front, rear, etc.) are used merely to explain the relative positional relationships and movements of the components under a specific posture (as shown in the drawings). If the specific posture changes, the directional instructions will correspondingly change as well.

Additionally, the descriptions of “first” “second” and similar terms in the present application are only for illustrative purposes and should not be understood as indicating or implying relative importance, nor do they imply a specific number of technical features. Therefore, a feature defined as “first” or “second” may explicitly or implicitly include at least one such feature. Furthermore, the term “and/or” in the full text includes three options. Taking “A and/or B” as an example, it includes option A, or option B, or an option that both A and B satisfy. In addition, the technical solutions in the various embodiments can be combined with each other, provided that those skilled in the art can implement such combinations. When technical solutions are contradictory or cannot be implemented when combined, it should be considered that such combinations do not exist and are not within the protection scope of the present application.

The present application provides a flow valve 100.

The flow valve 100 can be applied to a water heater 1000 or other hot water systems that need to realize a bypass water mixing function. The following mainly describes the application of the flow valve 100 in a water heater 1000 as an example. The water heater 1000 is specifically described by taking a gas water heater 1000 with a coilless heat exchanger 200 as an example.

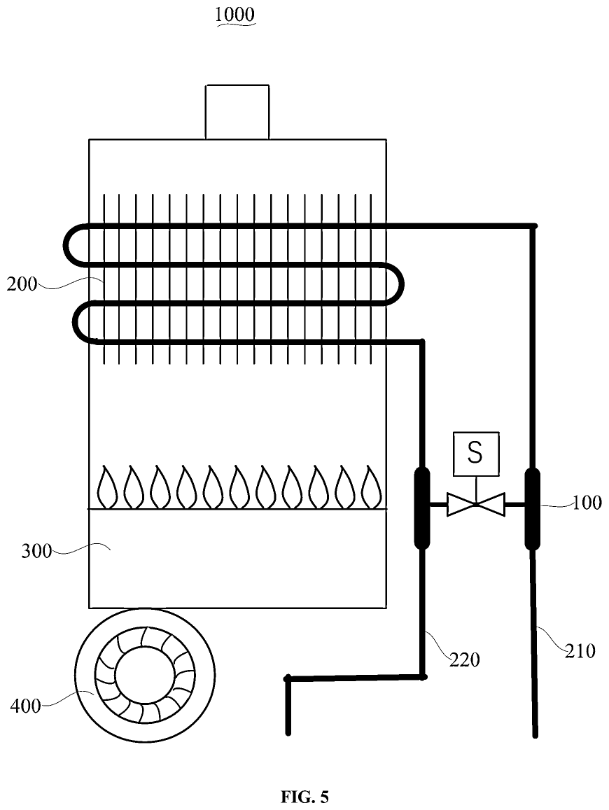

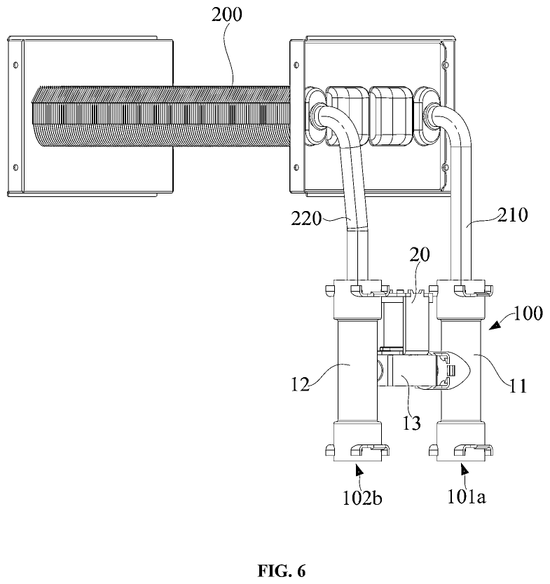

As shown in FIG. 5 and FIG. 6, the water heater 1000 generally includes a heat exchanger 200, a burner 300 and a fan 400. The heat exchanger 200 includes a heat exchange tube, a heat exchange plate sleeved on the outer periphery of the heat exchange tube, a cold water inlet tube 210 connected to the water inlet end of the heat exchange tube, and a hot water outlet tube 220 connected to the water outlet end of the heat exchange tube. The burner 300 is provided below the heat exchanger 200. For a strong drum type gas water heater 1000, the fan 400 is provided below the burner 300; for a strong extraction type gas water heater 1000, the fan 400 is provided above the heat exchanger 200. When the water heater 1000 is working, the fan 400 starts, and the mixture of gas and air enters the burner 300 for combustion. The cold water in the external water supply system can enter the heat exchange tube of the heat exchanger 200 through the cold water inlet tube 210. The high-temperature flue gas generated by the burner 300 flows upward to exchange heat with the heat exchanger 200 to heat the water in the heat exchange tube. The heated hot water can be output to the user end through the hot water outlet tube 220 to provide hot water to the user.

Conventional water heaters usually connect a bypass tube between the cold water inlet tube and the hot water outlet tube of the heat exchanger to achieve the bypass water mixing function. When the water heater is working, part of the cold water in the cold water inlet tube will enter the hot water outlet tube through the bypass tube to achieve the mixing of cold water and hot water. According to research, water heaters with such a bypass structure have at least the following defects.

Firstly, when the water heater is burning normally, the flow path in the bypass tube always remains in a communicated-state, so the highest temperature in the heat exchange tube is higher than the set temperature of the water heater. The set temperature is reached only after the cold water is mixed. In order to solve the temperature rise when the water is shut off, a large bypass ratio may be required. If the set temperature of the water heater is 65° C., the actual temperature in the heat exchange tube will be as high as 75° C., which will produce serious gasification noise, affect the user experience, and shorten the life of the heat exchanger.

Secondly, if the bypass ratio is too large, serious vaporization noise will be generated and the thermal efficiency of the heat exchanger will be reduced. Generally, the bypass ratio cannot be set too high. Since the coilless heat exchanger lacks coil water cooling, the water-off temperature rise is high, and a large bypass ratio may be required to reduce the water-off temperature rise, which further causes the adverse effects of high vaporization noise and low thermal efficiency.

Lastly, since the bypass tube is always open and the bypass ratio is fixed, if the bypass ratio is too large, it is easy to cause large overshoot during start-stop in winter; and if the bypass ratio is too small, it is easy to cause the outlet water temperature to be too high or the risk of condensation in summer.

The water-off temperature rise or the overshoot during start-stop refers to the fact that when the water heater is working normally, the fin tube (that is, the heat exchange tube with heat exchanger fins) is in a high temperature state. When the water heater stops working, the heat on the fin tube will be quickly transferred to the stopped water, causing the water temperature to rise. When the water heater is restarted, a section of high-temperature water will flow out, which may scald the user in severe cases. The water-off temperature drop/overshoot during start-stop refers to the fact that after the water heater stops working, it may need to be pre-cleaned and ignited when it is restarted. At this time, a section of cold water will flow out of the heat exchanger before it can be heated to the set temperature. The start-stop constant temperature process refers to the fact that there is a part of normal temperature hot water in the user's hot water pipeline. After the burner is restarted, it will first experience a normal water temperature, then experience an overshoot (water-off temperature rise) and an undershoot (water-off temperature drop), and finally reach the normal set temperature. The bypass ratio refers to the ratio of the bypass flow to the main line flow. The bypass cold water flow plus the main line flow equals the total flow.

The inventor has found that, at present, there is no flow valve on the market that can be well applied to the piping system of the water heater, so that the water heater has a bypass water mixing function, and can effectively improve the problems of constant temperature difference between start and stop, high vaporization noise, low thermal efficiency, etc. In addition, the valve body of most flow valves is an integrated structure. When the flow channel inside the valve body is complex, it will increase the difficulty of manufacturing the valve body, which is not suitable for mass production. Based on this, the present application provides a flow valve 100, which is used to be set inside the water heater 1000. The flow valve 100 can be well applied to the piping system of the water heater 1000, so that the water heater 1000 has a bypass water mixing function, and can effectively improve the problems of constant temperature difference between start and stop, high vaporization noise, low thermal efficiency, etc. in conventional water heaters. Besides, the flow valve 100 has low processing and manufacturing difficulty and is suitable for mass production.

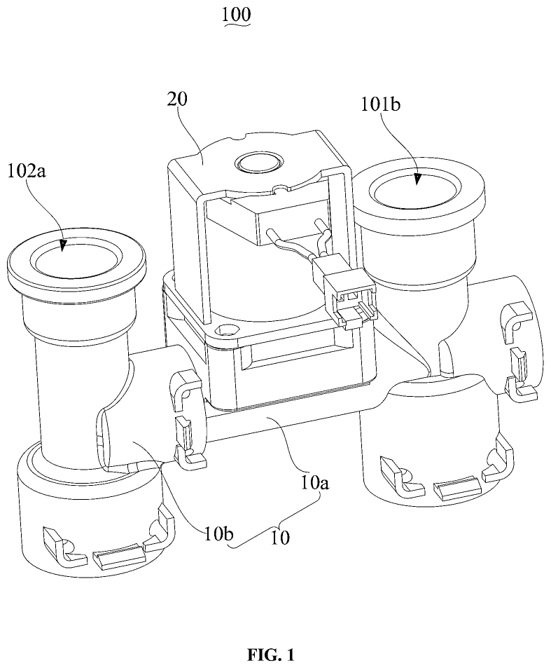

As shown in FIG. 1 to FIG. 4, in some embodiments of the present application, the flow valve 100 includes a first valve body 10a, a second valve body 10b and a controller 20. The first valve body 10a is provided with a first water inlet 101a, a first water outlet 101b and a bypass port 101c. A first flow channel 111 and a bypass flow channel 131 are constructed inside the first valve body 10a. The first flow channel 111 is communicated with the first water inlet 101a and the first water outlet 101b. The two ends of the bypass flow channel 131 are communicated with the first flow channel 111 and the bypass port 101c respectively. The second valve body 10b is detachably connected to the first valve body 10a. The second valve body 10b is provided with a second water inlet 102a, a second water outlet 102b and a water passage 122. A second flow channel 121 is constructed inside the second valve body 10b. The second flow channel 121 is communicated with the second water inlet 102a and the second water outlet 102b. The bypass port 101c is communicated with the second flow channel 121 via the water passage 122. The controller 20 is provided at the first valve body 10a, and the controller 20 is used to control the water flow rate of the bypass flow channel 131.

In some embodiments, the valve body 10 of the flow valve 100 is composed of a first valve body 10a and a second valve body 10b. The first valve body 10a and the second valve body 10b can be made of metal parts or high temperature resistant plastic pieces. The first valve body 10a is integrated with a controller 20. The first valve body 10a and the second valve body 10b can be separately processed and manufactured and then assembled. The connection method between the first valve body 10a and the second valve body 10b includes but is not limited to one or a combination of several methods such as plug-in matching, snap-fit matching, threaded connection, and screw connection. When applied to the pipeline system of the water heater 1000, one of the first flow channel 111 and the second flow channel 121 can be used as an inlet flow channel, and the other as an outlet flow channel. The bypass flow channel 131 is used to transport the water in the inlet flow channel to the outlet flow channel to achieve bypass mixing. The flow valve 100 can be well applied to the pipeline system of the water heater 1000, so that the water heater 1000 has a bypass mixing function. The controller 20 is installed at a position corresponding to the first valve body 10a and the bypass flow channel 131, and the water flow rate of the bypass flow channel 131 can be controlled by the controller 20.

It should be noted that the controller 20 controls the water flow rate of the bypass flow channel 131, which should be understood as the water flow rate through the bypass flow channel 131 can be changed to a certain extent under the control of the controller 20. The change in water flow rate here can be a change between no flow and flow, or a change between a large flow and a small flow when there is flow. The controller 20 includes but is not limited to the use of a solenoid valve, a proportional valve, etc.

The cold water inlet tube and the hot water outlet tube of the conventional water heater are placed on both sides of the width direction of the water heater, and the distance between the two is large. Usually, a long bypass tube may need to be connected. It is not easy to connect and install with the flow valve in actual production, the cost is high, and the sealing performance is difficult to ensure. As shown in FIG. 5 and FIG. 6, in some embodiments, the cold water inlet tube 210 and the hot water outlet tube 220 of the water heater 1000 with the flow valve 100 can be provided at the same side of the water heater 1000. The distance between the two is relatively short, which is suitable for the installation of the flow valve 100, and the long bypass tube can be omitted, which can reduce the cost and ensure the sealing performance. The first flow channel 111 is connected in series with the flow channel in the cold water inlet tube 210, and the second flow channel 121 is connected in series with the flow channel in the hot water outlet tube 220. At this time, the first flow channel 111 is the water inlet flow channel, and the second flow channel 121 is the water outlet flow channel. Cold water enters the first flow channel 111 through the first water inlet 101a, and is then output to the heat exchange tube of the heat exchanger 200 through the first water outlet 101b. The hot water in the heat exchange tube enters the second flow channel 121 through the second water inlet 102a, and is then output through the second water outlet 102b. The controller 20 of the flow valve 100 can be electrically connected to the control system of the water heater 1000 in a wired or wireless manner. The control system sends corresponding control instructions to the controller 20 according to the working state of the water heater 1000, and then the water flow rate of the bypass flow channel 131 can be controlled by the controller 20.

As shown in FIG. 5 and FIG. 6, the specific control process of the flow valve 100 when the water heater 1000 is working will be described in detail below.

When the water heater 1000 is working normally, the controller 20 controls the closing of the bypass flow channel 131. At this time, the highest temperature in the heat exchange tube of the heat exchanger 200 is the set temperature of the water heater 1000. In this way, the risk of vaporization noise can be greatly reduced, and the thermal efficiency of the heat exchanger 200 will not be affected, and the service life of the heat exchanger 200 can also be extended.

After the water supply to the water heater 1000 is stopped, the controller 20 controls the bypass flow channel 131 to be opened, and can close the bypass flow channel 131 within a few seconds of startup according to the actual working conditions. At this time, part of the cold water in the first flow channel 111 is transported to the second flow channel 121 via the bypass flow channel 131, and the cold water is mixed with the high-temperature water in the second flow channel 121, which can effectively reduce the temperature rise when the water supply is stopped. Since part of the cold water is diverted from the bypass flow channel 131, the water flow rate transported by the first flow channel 111 toward the first water outlet 101b is reduced, which can reduce the overshoot at startup.

In addition, it is also possible to determine whether to open the bypass during normal combustion based on actual working conditions. For example, in winter, when the temperature difference between the inlet and outlet water is large and may need to be quickly heated to the set temperature, the controller 20 controls the bypass flow channel 131 to close. This not only improves the heating speed but also ensures that it can be heated to the set temperature. When the water is stopped and restarted, the bypass time can be reduced to reduce overshoot. When a low-temperature bath is needed in summer, the controller 20 controls the bypass flow channel 131 to open. At this time, the minimum temperature rise of the water heater 1000 can be reduced to prevent the water temperature from being too hot during bathing, and the water temperature in the heat exchange tube can be increased, the flue gas temperature can be increased, and the risk of condensation water can be avoided.

The flow valve 100 of the present application includes a first valve body 10a, a second valve body 10b, and a controller 20 provided at the first valve body 10a. The first valve body 10a and the second valve body 10b are assembled to form the valve body 10 of the flow valve 100. The valve body 10 is constructed with a first flow channel 111 communicating the first water inlet 101a and the first water outlet 101b, a second flow channel 121 communicating the second water inlet 102a and the second water outlet 102b, and a bypass flow channel 131 communicating the first flow channel 111 and the second flow channel 121. The controller 20 is used to control the water flow rate of the bypass flow channel 131. When the flow valve 100 is applied to the water heater 1000, the valve body 10 is connected in series to the cold water inlet tube 210 and the hot water outlet tube 220 of the heat exchanger 200 at the same time. The first flow channel 111 can be used as an inlet flow channel connected to the cold water inlet tube 210, and the second flow channel 121 can be used as an outlet flow channel connected to the hot water outlet tube 220, and the cold water in the first flow channel 111 can be transported to the second flow channel 121 through the bypass flow channel 131. The flow valve 100 can be well applied to the piping system of the water heater 1000 so that the water heater 1000 has a bypass water mixing function. The controller 20 is used to be electrically connected to the control system of the water heater 1000. The control system sends corresponding control instructions to the controller 20 according to the working state of the water heater 1000, and then the water flow rate of the bypass flow channel 131 can be controlled by the controller 20. The bypass mixed water volume of the water heater 1000 can be adjusted according to the actual working conditions, which can effectively improve the problems of the start-stop constant temperature difference, high vaporization noise, and low thermal efficiency of the conventional water heater.

The valve body 10 of the flow valve 100 includes a first valve body 10a and a second valve body 10b that are separately provided. When the valve body 10 is manufactured, the first valve body 10a and the second valve body 10b can be formed separately, and then the first valve body 10a and the second valve body 10b can be assembled. Compared with the valve body 10 of the integrated structure, the first valve body 10a and the second valve body 10b have simple structures and are easy to process and form, thereby reducing the manufacturing difficulty of the valve body 10, so that the manufacturing difficulty of the flow valve 100 is low and suitable for mass production.

In addition, the first valve body 10a and the second valve body 10b are detachably connected. After the first valve body 10a and the second valve body 10b are separated, the first valve body 10a can be used as a flow regulating valve with a controller 20, and the second valve body 10b can be used as a three-way valve, so that the flow valve 100 can be suitable for more application scenarios.

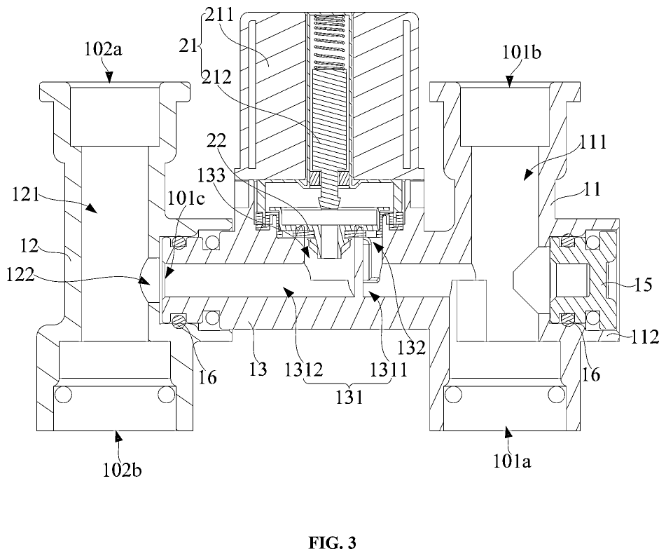

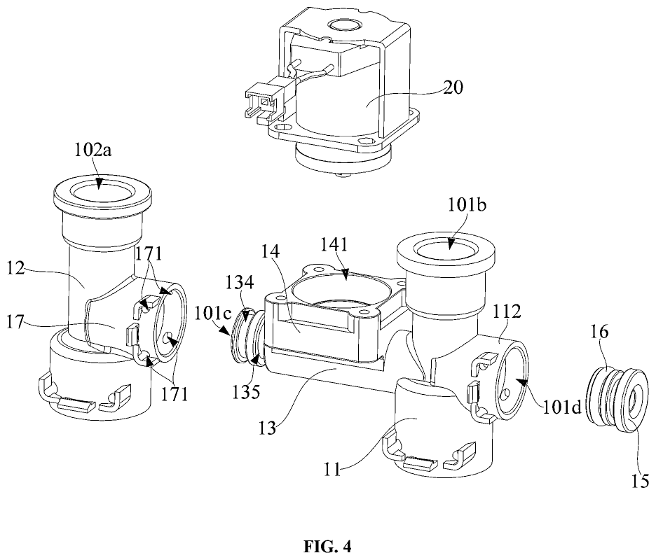

As shown in FIG. 3 and FIG. 4, in some embodiments, the first valve body 10an includes a first tube body 11 and a bypass tube body 13, the first tube body 11 has a first flow channel 111 formed inside, the first tube body 11 has a first water inlet 101a and a first water outlet 101b at both ends, the bypass tube body 13 has a bypass flow channel 131 formed inside, one end of the bypass tube body 13 is connected to the peripheral wall of the first tube body 11, and the other end of the bypass tube body 13 is provided with a bypass port 101c. The second valve body 10b includes a second tube body 12 extending in parallel with the first tube body 11 and provided at an interval. The second flow channel 121 is formed inside the second tube body 12, the second water inlet 102a and the second water outlet 102b are respectively provided at both ends of the second tube body 12, the water passage 122 is provided at the peripheral wall of the second tube body 12, and the bypass tube body 13 is provided with one end of the bypass port 101c and is detachably connected to the part of the second tube body 12 provided with the water passage 122.

In some embodiments, the first valve body 10a is generally a “T” type valve structure. When assembling, the valve body 10 can be obtained by detachably connecting one end of the bypass tube body 13 provided with the bypass port 101c to the part of the second tube body 12 provided with the water port 132. The first tube body 11 and the second tube body 12 extend in parallel and are provided at intervals. The parallel extension here means that the axis of the first tube body 11 is parallel or substantially parallel to the axis of the second tube body 12. The bypass tube body 13 is connected between the first tube body 11 and the second tube body 12. The axis of the bypass tube body 13 can be perpendicular to or obliquely intersected with the axis of the first tube body 11 (or the second tube body 12). The valve body 10 generally presents an “H” type valve or an “N” type valve structure. In this way, the overall structure of the valve body 10 is regular, suitable for connecting with the cold water inlet tube 210 and the hot water outlet tube 220 of the heat exchanger 200, which is conducive to reducing the overall volume of the water heater 1000. The controller 20 is provided at the peripheral wall of the bypass tube body 13 so as to control the bypass flow channel 131.

In order to facilitate the assembly of the first valve body 10a and the second valve body 10b, as shown in FIG. 4, in some embodiments, the second valve body 10b further includes an insert sleeve 17 provided at the peripheral wall of the second tube body 12, the insert sleeve 17 is provided around the outer periphery of the water passage 122 and extends toward the first tube body 11, and one end of the bypass tube body 13 provided with the bypass port 101c is detachably sealed and plugged into the insert sleeve 17. Specifically, during assembly, the end of the bypass tube body 13 provided with the bypass port 101c is inserted into the insert sleeve 17, and the bypass tube body 13 and the insert sleeve 17 can be sealed and fixedly connected by interference fit, colloid sealing, or fastener locking.

In order to ensure the sealing reliability between the bypass tube body 13 and the insert sleeve 17, as shown in FIG. 3 and FIG. 4, in some embodiments, the first valve body 10a further includes a seal ring 16 sleeved on the outer periphery of the bypass tube body 13, the outer peripheral wall of the bypass tube body 13 is provided with a seal groove 134 for accommodating the seal ring 16, and the seal ring 16 is sealed with the inner peripheral wall of the insert sleeve 17. When the bypass tube body 13 and the insert sleeve 17 are plugged into place, the seal ring 16 is squeezed and deformed to form a reliable sealing connection with the inner peripheral wall of the insert sleeve 17, thereby reducing the risk of water leakage. By providing the seal groove 134, the movement of the seal ring 16 along the axial direction of the bypass tube body 13 can be restricted, so as to prevent the seal ring 16 from moving along the axial direction of the bypass tube body 13 during the plugging and unplugging process of the bypass tube body 13 and failing to play a sealing role.

In order to further improve the assembly reliability and disassembly convenience between the bypass tube body 13 and the insert sleeve 17, as shown in FIG. 4, in some embodiments, the peripheral wall of the insert sleeve 17 is provided with an insertion hole 171 for inserting a plug, and the outer peripheral wall of the bypass tube body 13 is provided with a clamping groove 135 for clamping with the plug, and the insert sleeve 17 and the bypass tube body 13 are locked and fixed by the plug. During assembly, when the bypass tube body 13 and the insert sleeve 17 are plugged into place, the plug is inserted into the insert sleeve 17 from the insertion hole 171, and the plug is clamped with the clamping groove 135 on the bypass tube body 13, so that the bypass tube body 13 and the insert sleeve 17 can be locked and fixed, so as to improve the assembly reliability and sealing reliability between the bypass tube body 13 and the insert sleeve 17. When the first valve body 10a and the second valve body 10b are to be separated, the plug is pulled out from the insertion hole 171, and then a certain pulling force is applied to separate the bypass tube body 13 from the insert sleeve 17, which can improve the convenience of disassembly and assembly. In some embodiments, the plug adopts a U-shaped plug with two pins, and the peripheral wall of the insert sleeve 17 is provided with an insertion hole 171 for the two pins of the plug to be inserted, and each insertion hole 171 penetrates the opposite sides of the insert sleeve 17 along the radial direction of the insert sleeve 17. Other interface parts of the valve body 10 (such as the first water inlet 101a, the first water outlet 101b, the second water inlet 102a, the second water outlet 102b, and the external port 101d) can also adopt a structure in which the plug and the insert hole cooperate to realize assembly with the pipeline. For details, as shown in the method of some embodiments, which will not be repeated here.

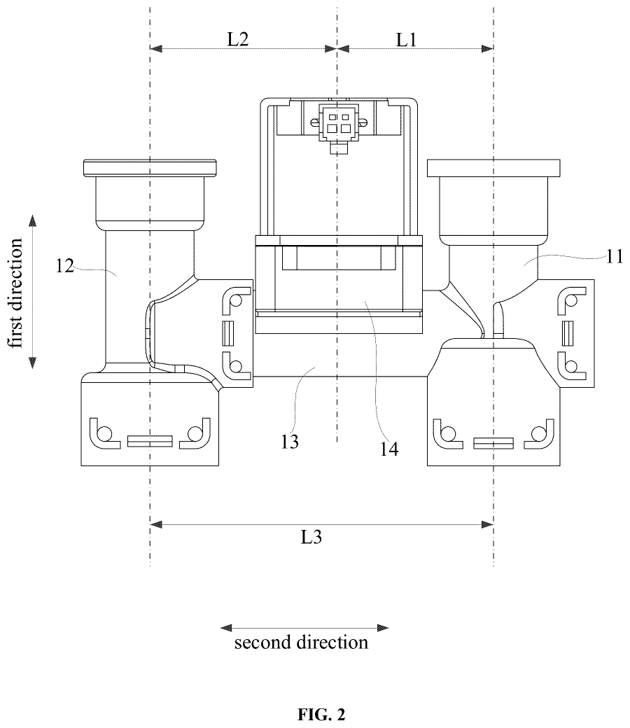

As shown in FIG. 2, in some embodiments, the first tube body 11 and the second tube body 12 are both extended along the first direction, the bypass tube body 13 is extended along the second direction, the two ends of the bypass tube body 13 are respectively connected to the middle of the first tube body 11 and the middle of the second tube body 12, and the controller 20 is provided at one side of the bypass tube body 13 in the first direction, where the first direction intersects with the second direction.

In some embodiments, as shown in FIG. 5 and FIG. 6, when the flow valve 100 is applied to the water heater 1000, since the cold water inlet tube 210 and the hot water outlet tube 220 of the water heater 1000 are usually extended along the height direction of the water heater 1000, accordingly, the first direction is the height direction of the water heater 1000. Therefore, the first tube body 11 and the second tube body 12 are both vertical pipes extending along the height direction of the water heater 1000, so as to facilitate the first tube body 11 and the second tube body 12 to be connected in series with the cold water inlet tube 210 and the hot water outlet tube 220 respectively, so as to improve the installation compatibility of the flow valve 100 and the heat exchanger 200. The second direction can be the thickness direction (also such as the front-to-back direction) or the width direction (such as the left-to-right direction) of the water heater 1000, and the first direction and the second direction can be perpendicular to each other or have a certain inclination angle. Since the bypass tube body 13 is relatively short, the second direction is the thickness direction of the water heater 1000, which is beneficial for fully utilizing the space in the thickness direction of the water heater 1000 to reduce the width dimension of the water heater 1000.

The two ends of the bypass tube body 13 are respectively connected to the middle of the first tube body 11 and the middle of the second tube body 12, so that the valve body 10 generally presents an “H”-shaped valve structure. Since the two ends of the first tube body 11 and the two ends of the second tube body 12 are extended by one end distance along the first direction compared with the bypass tube body 13. As such, in the first direction, the valve body 10 is respectively formed with concave cavities on the opposite sides corresponding to the bypass tube body 13, and the controller 20 is provided at one side of the bypass tube body 13 in the first direction, and the controller 20 is at least partially accommodated in one of the concave cavities. In this way, the concave space constructed by the valve body 10 itself can be fully utilized to accommodate the controller 20, which is conducive to reducing the overall volume of the flow valve 100. For example, in some embodiments, the valve body 10 is respectively formed with concave cavities on the upper and lower sides corresponding to the bypass tube body 13, and the controller 20 can be installed on the upper side of the bypass tube to be at least partially accommodated in the concave cavity on the upper side. In some embodiments, the controller 20 may also be installed on the lower side, front side or rear side of the bypass tube body 13.

As shown in FIG. 2, in some embodiments, the peripheral wall of the bypass tube body 13 is provided with an installation base 14 for installing the controller 20, the installation base 14 has a center line extending along the first direction, and the distance between the center line and the axis of the first tube body 11 is L1, and the distance between the center line and the axis of the second tube body 12 is L2, where L1 is greater than L2.

In some embodiments, by providing an installation base 14 on the peripheral wall of the bypass tube body 13, the installation of the controller 20 can be facilitated. In some embodiments, the installation base 14 is integrally formed with the bypass tube body 13, which can simplify the assembly process and improve the structural strength. For example, in some embodiments, the installation base 14 is generally a square boss structure protruding from the peripheral wall of the bypass tube body 13, and the four corners of the installation base 14 can be provided with assembly holes for fasteners to pass through, and the middle of the installation base 14 is provided with a sink 141 for accommodating a partial structure of the controller 20, where the axis of the sink 141 is the center line of the installation base 14. The distance between the center line of the installation base 14 and the axis of the first tube body 11 is smaller than the distance between the center line of the installation base 14 and the axis of the second tube body 12, so that the distance between the controller 20 and the first tube body 11 is smaller, and the distance between the controller 20 and the second tube body 12 is farther. In actual application, the first tube body 11 can be a cold water pipe for cold water circulation, and the second tube body 12 can be a hot water pipe for hot water circulation. In this way, the controller 20 can be provided away from the hot water pipe (that is, the second tube body 12) to avoid the heat radiated by the hot water pipe from damaging the controller 20. At the same time, the controller 20 is provided closer to the cold water pipe (that is, the first tube body 11), which is beneficial to the heat dissipation of the controller 20 and extends the service life of the controller 20.

As shown in FIG. 2, in some embodiments, the distance between the axis of the first tube body 11 and the axis of the second tube body 12 is L3, where L3 is less than 100 mm. In this way, the effect of the length of the bypass tube body 13 and the assembly deformation on the bypass ratio and the bypass response speed can be reduced. Specifically, the distance between the first tube body 11 and the second tube body 12 is short, the length of the bypass tube body 13 is shortened, and the length of the bypass flow channel 131 can be shortened. The cold water in the first flow channel 111 can be quickly transported to the second flow channel 121 through the shorter bypass flow channel 131 to mix with the hot water in the second flow channel 121, which can ensure a faster bypass response speed and a more accurate bypass ratio. In addition, the shortened length of the bypass tube body 13 is conducive to improving the structural stability of the entire valve, and avoiding the deformation of the bypass tube body 13 after long-term use, which has an adverse effect on the bypass ratio and the bypass response speed, where L3 can be designed to be 90 mm, 80 mm, 70 mm, etc. as needed.

In order to further improve the installation compatibility of the flow valve 100 and the heat exchanger 200, as shown in FIG. 3, in some embodiments, the first water inlet 101a and the second water inlet 102a are provided diagonally, and the first water outlet 101b and the second water outlet 102b are provided diagonally. Taking the flow valve 100 placed vertically as an example, the lower end of the first tube body 11 is provided with a first water inlet 101a, the upper end of the first tube body 11 is provided with a first water outlet 101b, the upper end of the second tube body 12 is provided with a second water inlet 102a, and the lower end of the second tube body 12 is provided with a second water outlet 102b. In this way, the water flow direction in the first flow channel 111 is consistent with the water flow direction in the cold water inlet tube 210 of the heat exchanger 200, and the water flow direction in the second flow channel 121 is consistent with the water flow direction in the cold water outlet tube of the heat exchanger 200. In this way, the flow valve 100 can be installed in the pipeline system of the heat exchanger 200 without changing the pipeline direction of the heat exchanger 200. In some embodiments, the inner diameter of the first tube body 11 is greater than the inner diameter of the bypass tube body 13, and the bypass ratio is not less than 42%.

Specifically, when the flow valve 100 is applied to the water heater 1000, the first tube body 11 is connected to the cold water inlet tube 210 of the heat exchanger 200, and the second tube body 12 is connected to the hot water outlet tube 220 of the heat exchanger 200. The inner diameter of the first tube body 11 is larger than the inner diameter of the bypass tube body 13, most of the cold water in the first tube body 11 can be transported to the heat exchanger 200, and a small part of the water is diverted to the bypass tube body 13, which can avoid too little water transported to the heat exchanger 200 and directly vaporize, affecting the efficiency of preparing hot water, and also avoid too much water transported from the bypass tube body 13 to the second tube body 12, which causes the hot water in the second tube body 12 to cool too much. Furthermore, the inner diameter of the first tube body 11 and the inner diameter of the bypass tube body 13 are designed to ensure that the bypass ratio is not less than 42%, that is, to ensure that the water flowing from the first flow channel 111 to the bypass flow channel 131 is greater than or equal to 42%, so as to ensure that a good bypass water mixing effect can be achieved. In addition, in order to avoid excessive bypass water volume causing a large impact and temperature drop on the hot water in the second tube body 12, the inner diameter of the second tube body 12 is larger than the inner diameter of the bypass tube body 13.

As shown in FIG. 3, in some embodiments, the area of the water passage 122 is larger than the area of the bypass port 101c. In this way, when the water in the bypass flow channel 131 is output from the bypass port 101c, it is possible to avoid excessive resistance to the water flow due to the small area of the water passage 122, which is conducive to the rapid delivery of the water in the bypass flow channel 131 to the second flow channel 121.

As shown in FIG. 3, in some embodiments, the bypass flow channel 131 includes a first bypass section 1311 and a second bypass section 1312 separated from each other, and the peripheral wall of the bypass tube body 13 is provided with a first water outlet 132 and a second water outlet 133, the first bypass section 1311 communicates the first flow channel 111 and the first water outlet 132, and the second bypass section 1312 communicates the second water outlet 133 and the second flow channel 121. The controller 20 includes a driver 21 and a seal 22, and the driver 21 cooperates with the seal 22 to make the first water outlet 132 and the second water outlet 133 communicated or isolated.

In some embodiments, a partition is provided inside the bypass tube body 13, and the partition divides the bypass flow channel 131 into a first bypass section 1311 and a second bypass section 1312. The peripheral wall of the bypass tube body 13 is provided with a first water outlet 132 and a second water outlet 133 on opposite sides of the partition. When the bypass flow channel 131 is to be closed, the driving end of the driver 21 abuts against the seal 22. At this time, the driver 21 cooperates with the seal 22 to block the first water outlet 132 and the second water outlet 133 to ensure the sealing performance. After the water in the first flow channel 111 enters the first bypass section 1311, it cannot be further transported forward to the second bypass section 1312. When the bypass flow channel 131 is to be opened, the driver 21 can drive the seal 22 away from the peripheral wall of the bypass tube body 13 to make the first water outlet 132 and the second water outlet 133 communicated, or the driving end of the driver 21 can be moved away from the seal 22 to make the seal 22 produce a certain displacement or deformation under the water flow pressure to make the first water outlet 132 and the second water outlet 133 communicated. At this time, the first bypass section 1311 is communicated with the second bypass section 1312, and the bypass water mixing function can be realized.

As shown in FIG. 3 and FIG. 4, in some embodiments, the peripheral wall of the bypass tube body 13 is provided with an installation base 14 for installing the drive assembly 21, the installation base 14 is provided with a sink 141 for accommodating the seal 22, the bottom wall of the sink 141 is provided with the first water outlet 132 and the second water outlet 133. The drive assembly 21 includes a motor 211 and a push rod 212 drivingly connected to the motor 211, the motor 211 blocks the top opening of the sink 141. The push rod 212 is extended toward the seal 22, and the motor 211 is used to drive the push rod 212 to perform telescopic movement. When the push rod 212 is in an extended state, the push rod 212 presses against the seal 22 to block the first water outlet 132 and the second water outlet 133. When the push rod 212 is in a retracted state, a water flow channel communicating the first water outlet 132 and the second water outlet 133 is defined between the seal 22 and the bypass tube body 13.

In some embodiments, the motor 211 is fixed to the installation base 14 and blocks the top opening of the sink 141. The seal 22 is located in the closed cavity defined by the motor 211 and the bypass tube body 13, which can prevent the water in the bypass tube body 13 from leaking out and causing damage to the motor 211. When the bypass flow channel 131 is to be closed, the push rod 212 abuts against the seal 22 to block the first water outlet 132 and the second water outlet 133. At this time, the push rod 212 generates a certain pressure on the seal 22, which can prevent the seal 22 from being displaced under the action of water pressure and losing its sealing function. The seal 22 may be a flexible diaphragm. When the bypass flow channel 131 is to be opened, the push rod 212 retracts and separates from the seal 22. The seal 22 moves toward the side away from the bypass flow channel 131 or partially deforms under the water pressure in the bypass flow channel 131. A water flow channel is formed between the seal 22 and the bypass tube body 13 to connect the first water outlet 132 with the second water outlet 133. There are many ways for the motor 211 to drive the push rod 212 to achieve telescopic movement. For example, in some embodiments, the controller 20 may be an electromagnetic valve. Accordingly, the motor 211 may be an electromagnetic coil of the electromagnetic valve, and the push rod 212 may be an iron core provided in the electromagnetic coil. When the electromagnetic coil is energized, the iron core is driven to move. In other embodiments, the motor 211 may also use other mechanical structures to drive the push rod 212 to perform telescopic movement.

As shown in FIG. 3 and FIG. 4, in some embodiments, an extension part 112 is provided at a side of the first tube body 11 away from the bypass tube body 13, and the extension part 112 is provided with an external port 101d opposite to and communicated with the bypass flow channel 131. The valve body 10 further includes a seal plug 15 detachably connected to the extension part 112, and the seal plug 15 is used to open or block the external port 101d.

In some embodiments, the extension part 112 is a hollow cylindrical structure extending from the peripheral wall of the first tube body 11 toward a side away from the bypass tube body 13, and the inner cavity of the extension part 112 forms an external port 101d. When manufacturing the valve body 10, a drilling tool can be inserted into the valve body 10 through the external port 101d to facilitate processing of the bypass flow channel 131 inside the valve body 10. When the flow valve 100 is in normal use, the external port 101d is blocked by the seal plug 15, which can prevent the water in the valve body 10 from leaking from the external port 101d. In addition, the external port 101d can also be used as another connection port of the valve body 10. When it is necessary to connect with other pipelines, the seal plug 15 can be taken out from the external port 101d to expand the quantity of connection ports of the valve body 10.

In some embodiments, in order to ensure the sealing reliability between the seal plug 15 and the extension part 112, a seal ring 16 is provided at the outer peripheral wall of the seal plug 15. When the seal plug 15 seals the external port 101d, the seal ring 16 is squeezed and deformed to seal with the inner peripheral surface of the extension part 112.

In some embodiments, the first valve body 10a and/or the second valve body 10b are provided with a connection part, and the connection part is used to be connected and fixed with the back plate of the water heater 1000. Specifically, after the water heater 1000 is installed at the wall, the back plate of the water heater is provided close to the wall, and the valve body 10 formed by assembling the first valve body 10a and the second valve body 10b is connected and fixed with the back plate through the connection part, so that the installation of the flow valve 100 is more stable and reliable, and the flow valve 100 is prevented from shaking during the operation of the water heater 1000, thereby ensuring the working reliability of the flow valve 100. The specific setting position of the connection part can be set according to actual conditions, for example, the connection part can be set only on the first valve body 10a, or only on the second valve body 10b, or on both the first valve body 10a and the second valve body 10b. For example, in a specific application, the first valve body 10a of the flow valve 100 is provided close to the back plate, and the connection part can be set on the first valve body 10a.

Furthermore, the first valve body 10a and/or the second valve body 10b are integrally formed with the connection part, and the connection part is connected and fixed to the back plate via a connection piece. The first valve body 10a and/or the second valve body 10b are integrally formed with the connection part, so that the structural strength of the connection part is higher and it is easy to produce and manufacture. The connection part is connected and fixed to the back plate via a connection piece (such as a screw, a bolt, a latch, etc.), the assembly is simple and convenient, and the connection is stable and reliable. In some embodiments, the first valve body 10a, the second valve body 10b and the connection part are plastic pieces. In this way, it is easy to integrally injection mold the first valve body 10a and the connection part, or integrally injection mold the second valve body 10b and the connection part, and the manufacturing process is simple.

Based on the above embodiments, in some embodiments, the flow valve 100 further includes a flow sensor provided at the first valve body 10a, and the flow sensor is used to detect the water inlet flow of the first flow channel 111; and/or, the flow valve 100 further includes a temperature sensor provided at the first valve body 10a, and the temperature sensor is used to detect the water inlet temperature of the first flow channel 111.

In some embodiments, the first valve body 10a of the flow valve 100 can be used as a mounting carrier for the flow sensor and/or the temperature sensor, so that the flow valve 100 has a higher degree of integration and more diversified functions. It is no longer necessary to install a flow sensor and/or a temperature sensor on the cold water inlet tube 210 of the water heater 1000, which is conducive to reducing the quantity of parts to be assembled, improving assembly efficiency, and reducing costs. At the same time, it can also reduce the risk of water leakage caused by the assembly of parts. When the flow valve 100 is applied to the water heater 1000, the installation position of the flow valve 100 can be provided closer to the water inlet end of the cold water inlet tube 210 (that is, replacing the original installation position of the flow sensor and/or the temperature sensor), and the flow valve 100 is away from the heat radiation area formed by the burner 300, so as to avoid the electronic components integrated in the flow valve 100 from being damaged by heat radiation, and the service life of the flow valve 100 can be extended.

For example, the water inlet end of the first tube body 11 (i.e., the end provided with the first water inlet 101a) may be provided with an extension tube body, a rotor is provided inside the extension tube body, and a Hall element is provided at the peripheral wall of the extension tube body, so that the extension tube body, the rotor and the Hall element are combined to form a flow sensor. When water flows through, it drives the rotor to rotate, and then the rotation speed of the rotor is detected by the Hall element, so as to calculate the water flow rate flowing through. The form of the flow sensor is not limited to this, and other forms of flow sensors can also be used. In addition, a temperature sensor can also be provided at the peripheral wall of the extension tube body, and the probe of the temperature sensor extends into the interior of the extension tube body to detect the inlet water temperature. The temperature sensor includes but is not limited to the use of thermocouple temperature sensors, thermistor temperature sensors, etc.

In some embodiments, the controller 20 is a solenoid valve or a proportional valve. For example, the controller 20 can use a solenoid valve to control the on and off of the bypass flow channel 131, so that the bypass flow channel 131 can be switched between two gears with bypass flow and without bypass flow, the adjustment is simple and convenient, and the response speed is fast. For another example, the controller 20 can use a proportional valve, and the proportional valve is equipped with a stepping motor to achieve continuous stepless adjustment with higher adjustment accuracy. In some embodiments, the controller 20 is only one of the solenoid valve or the proportional valve. In this way, under the premise of ensuring the realization of the bypass flow regulation function, the quantity of controllers 20 can be simplified, so that the overall structure of the flow valve 100 is more streamlined and smaller in size, which is also conducive to reducing costs.

The present application further provides a water heater 1000, which includes a heat exchanger 200 and a flow valve 100, where the water inlet and the water outlet of the heat exchanger 200 are both provided at the same side of the heat exchanger 200. The first water outlet 101b of the flow valve 100 is communicated with the water inlet of the heat exchanger 200 through a cold water inlet tube 210, and the second water inlet 102a of the flow valve 100 is connected to the water outlet of the heat exchanger 200 through a hot water outlet tube 220. The specific structure of the flow valve 100 refers to the above embodiments. Since the water heater 1000 adopts all the technical solutions of all the above embodiments, it has at least all the beneficial effects brought by the technical solutions of the above embodiments, which will not be repeated here. The water heater 1000 includes but is not limited to a strong drum type water heater with a fan placed below, or a strong extraction type water heater with a fan placed above.

As shown in FIG. 5 and FIG. 6, in some embodiments, the water heater 1000 includes a flow valve 100, a heat exchanger 200, a burner 300 and a fan 400. The burner 300 is provided below the heat exchanger 200, and the fan 400 is provided below the burner 300. The flow valve 100 can realize a precise intelligent bypass function to control the bypass mixed water temperature, and there is no need to wind a coil around the combustion chamber box of the water heater 1000. Therefore, the heat exchanger 200 can be a coil-free heat exchanger, which is conducive to further reducing the volume of the water heater 1000. At the same time, there is no need to set a coil, which can also reduce water leakage points and reduce water resistance pressure. The heat exchanger 200 may include a heat exchange tube, a heat exchange plate sleeved on the outer periphery of the heat exchange tube, a cold water inlet tube 210 connected to the water inlet end (i.e., water inlet) of the heat exchange tube, and a hot water outlet tube 220 connected to the water outlet end (i.e., water outlet) of the heat exchange tube. The water inlet and the water outlet of the heat exchanger 200 are provided at the same side. Accordingly, the cold water inlet tube 210 and the hot water outlet tube 220 are provided at the same side of the heat exchanger 200. The valve body 10 of the flow valve 100 is serially connected to the cold water inlet tube 210 and the hot water outlet tube 220. Specifically, the first tube body 11 of the first valve body 10a may be serially connected to the cold water inlet tube 210, and the second tube body 12 of the second valve body 10b may be serially connected to the hot water outlet tube 220. The controller 20 of the flow valve 100 can be electrically connected to the control system of the water heater 1000 in wire or wireless ways. The control system sends corresponding control instructions to the controller 20 according to the working state of the water heater 1000, and then the water flow rate of the bypass flow channel 131 can be controlled through the controller 20.

When the water heater 1000 is working normally, the controller 20 controls the bypass flow channel 131 to be closed. At this time, the highest temperature in the heat exchange tube of the heat exchanger 200 is the set temperature of the water heater 1000. In this way, the risk of vaporization noise can be greatly reduced, and the thermal efficiency of the heat exchanger 200 will not be affected, and the service life of the heat exchanger 200 can also be extended.

After the water supply to the water heater 1000 is stopped, the controller 20 controls the bypass flow channel 131 to be opened, and can close the bypass flow channel 131 within a few seconds of startup according to the actual working conditions. At this time, part of the cold water in the first flow channel 111 is transported to the second flow channel 121 via the bypass flow channel 131, and the cold water is mixed with the high-temperature water in the second flow channel 121, which can effectively reduce the temperature rise when the water supply is stopped. Since part of the cold water is diverted from the bypass flow channel 131, the water flow rate transported by the first flow channel 111 toward the first water outlet 101b is reduced, which can reduce the overshoot at startup.

In addition, it is also possible to determine whether to open the bypass during normal combustion based on actual working conditions. For example, in winter, when the temperature difference between the inlet and outlet water is large and needs to be quickly heated to the set temperature, the controller 20 controls the bypass flow channel 131 to close. This not only improves the heating speed but also ensures that it can be heated to the set temperature. When the water is stopped and restarted, the bypass time can be reduced to reduce overshoot. When a low-temperature bath is needed in summer, the controller 20 controls the bypass flow channel 131 to open. At this time, the minimum temperature rise of the water heater 1000 can be reduced to prevent the water temperature from being too hot during bathing, and the water temperature in the heat exchange tube can be increased, the flue gas temperature can be increased, and the risk of condensation water can be avoided.

The water heater 1000 of the present application is integrated with the flow valve 100 in the above embodiments. The control system of the water heater 1000 sends corresponding control instructions to the controller 20 according to the working state of the water heater 1000, and then the water flow rate of the bypass flow channel 131 can be controlled through the controller 20. The bypass mixed water volume of the water heater 1000 can be adjusted according to the actual working conditions, which can effectively improve the problems of the start-stop constant temperature difference, high vaporization noise, and low thermal efficiency of the conventional water heater. In addition, the cold water inlet tube 210 and the hot water outlet tube 220 of the water heater 1000 can be provided at the same side of the water heater 1000, and the distance between the two is relatively short, which is suitable for the installation of the flow valve 100. By installing a flow channel valve, the water inlet function, the water outlet function and the bypass mixed water function can be realized, and no other bypass tubes need to be installed, which can reduce costs and ensure sealing performance.

In some embodiments, the flow valve 100 is provided inside the water heater 1000 and adjacent to the heat exchanger 200. In this way, the flow valve 100 can more accurately control the accuracy of the upstream water flow and the bypass water flow, and more accurately control the temperature rise.

The flow valve of the present application includes a first valve body, a second valve body and a controller provided at the first valve body. The first valve body and the second valve body are assembled to form the valve body of the flow valve, and the valve body is constructed with a first flow channel communicating the first water inlet and the first water outlet, a second flow channel communicating the second water inlet and the second water outlet, and a bypass flow channel communicating the first flow channel and the second flow channel. The controller is used to control the water flow rate of the bypass flow channel. When the flow valve is applied to a water heater, the valve body is simultaneously connected in series to the cold water inlet tube and the hot water outlet tube of the heat exchanger, the first flow channel can be used as an inlet flow channel connected to the cold water inlet tube, the second flow channel can be used as an outlet flow channel connected to the hot water outlet tube, and the cold water in the first flow channel can be transported to the second flow channel through the bypass flow channel. The flow valve can be well applied to the piping system of the water heater, so that the water heater has a bypass water mixing function. The controller is used to be electrically connected to the control system of the water heater. The control system sends corresponding control instructions to the controller according to the working state of the water heater, and then the water flow rate of the bypass flow channel can be controlled through the controller. The bypass mixed water volume of the water heater can be adjusted according to the actual working conditions, which can effectively improve the problems of the start-stop constant temperature difference, high vaporization noise, low thermal efficiency, etc., of the conventional water heater. The valve body of the flow valve includes a first valve body and a second valve body that are separately provided. When manufacturing the valve body, the first valve body and the second valve body can be formed separately, and then the first valve body and the second valve body can be assembled. Compared with the valve body of the integrated structure, the structure of the first valve body and the second valve body is simple, which is easy to process and form, and can reduce the difficulty of manufacturing the valve body, so that the manufacturing difficulty of the flow valve is low and suitable for mass production.

The above descriptions are only some embodiments of the present application, and do not limit the scope of the present application. Under the inventive concept of the present application, equivalent structural transformations made using the contents of the description and drawings of the present application, or direct/indirect application in other related technical fields, are included in the scope of the present application.

1. A flow valve, provided inside a water heater, comprising:
a first valve body provided with a first water inlet, a first water outlet, and a bypass port;
a second valve body detachably connected to the first valve body and provided with a second water inlet, a second water outlet, and a water passage; and
a controller provided at the first valve body,
wherein a first flow channel and a bypass flow channel are constructed inside the first valve body, the first flow channel communicated with the first water inlet and the first water outlet, and two ends of the bypass flow channel respectively communicated with the first flow channel and the bypass port;
wherein a second flow channel is constructed inside the second valve body, the second flow channel communicated with the second water inlet and the second water outlet, and the bypass port communicated with the second flow channel via the water passage; and
wherein the controller is configured to control a water flow rate of the bypass flow channel.

2. The flow valve according to claim 1, wherein the first valve body comprises a first tube body and a bypass tube body, the first flow channel formed inside the first tube body, the first water inlet and the first water outlet respectively provided at two ends of the first tube body, the bypass flow channel formed inside the bypass tube body, one end of the bypass tube body connected to a peripheral wall of the first tube body, and another end of the bypass tube body provided with the bypass port; and
wherein the second valve body comprises a second tube body extending in parallel with the first tube body, the second tube body and the first tube body being spaced apart, the second flow channel formed inside the second tube body, the second water inlet and the second water outlet respectively provided at both ends of the second tube body, the water passage provided at a peripheral wall of the second tube body, and one end of the bypass tube body provided with the bypass port being detachably connected to a portion of the second tube body provided with the water passage.

3. The flow valve according to claim 2, wherein the second valve body further comprises an insert sleeve provided at the peripheral wall of the second tube body, the insert sleeve surrounding the water outlet and extending toward the first tube body, and one end of the bypass tube body provided with the bypass port being detachably sealed within the insert sleeve.

4. The flow valve according to claim 3, wherein the first valve body further comprises a seal ring sleeved on an outer periphery of the bypass tube body, an outer peripheral wall of the bypass tube body provided with a seal groove for accommodating the seal ring, and the seal ring sealingly cooperated with an inner peripheral wall of the insert sleeve; and/or,
wherein the peripheral wall of the insert sleeve is provided with an insert hole for inserting a pin, the outer peripheral wall of the bypass tube body provided with a slot for engaging with the pin, and the insert sleeve and the bypass tube body being locked and fixed by the pin.

5. The flow valve according to claim 2, wherein the first tube body and the second tube body extend along a first direction, wherein the bypass tube body extends along a second direction, the two ends of the bypass tube body respectively connected to a middle part of the first tube body and a middle part of the second tube body, and the controller provided at one side of the bypass tube body along the first direction; and
wherein the first direction intersects the second direction.

6. The flow valve according to claim 5, wherein an installation base for installing the controller is provided at the peripheral wall of the bypass tube body, the installation base having a center line extending along the first direction, a distance between the center line and an axis of the first tube body being L1, and a distance between the center line and an axis of the second tube body being L2, L1 being greater than L2; and/or,
wherein a distance between the axis of the first tube body and the axis of the second tube body is L3, and L3 being less than 100 mm.

7. The flow valve according to claim 1, wherein the first water inlet and the second water inlet are provided diagonally, wherein the first water outlet and the second water outlet are provided diagonally.

8. The flow valve according to claim 2, wherein an inner diameter of the first tube body is greater than an inner diameter of the bypass tube body, and a bypass ratio being not less than 42%; and/or,
wherein an area of the water passage is greater than an area of the bypass port.

9. The flow valve according to claim 1, wherein the first valve body and/or the second valve body is provided with a connection part to be connected and fixed to a back plate of the water heater.

10. The flow valve according to claim 9, wherein the first valve body and/or the second valve body are integrally formed with the connection part, and the connection part connected and fixed to the back plate through a connection piece; and/or,
wherein the first valve body, the second valve body, and the connection part are plastic pieces.

11. The flow valve according to claim 1,
wherein the flow valve further comprises a flow sensor provided at the first valve body to detect a water inlet flow of the first flow channel; and/or,
wherein the flow valve further comprises a temperature sensor provided at the first valve body to detect an inlet water temperature of the first flow channel; and/or,
wherein the controller is a solenoid valve or a proportional valve.

12. A water heater, comprising:
a heat exchanger; and
a flow valve provided inside a water heater, comprising:
a first valve body provided with a first water inlet, a first water outlet, and a bypass port;
a second valve body detachably connected to the first valve body and provided with a second water inlet, a second water outlet, and a water passage; and
a controller provided at the first valve body,
wherein a first flow channel and a bypass flow channel are constructed inside the first valve body, the first flow channel communicated with the first water inlet and the first water outlet, and two ends of the bypass flow channel respectively communicated with the first flow channel and the bypass port;
wherein a second flow channel is constructed inside the second valve body, the second flow channel communicated with the second water inlet and the second water outlet, and the bypass port communicated with the second flow channel via the water passage;
wherein the controller is configured to control a water flow rate of the bypass flow channel; and
wherein the first water outlet of the flow valve is communicated with a water inlet of the heat exchanger through a cold water inlet tube, wherein the second water outlet of the flow valve is communicated with a water outlet of the heat exchanger through a hot water outlet tube.

13. The water heater according to claim 12, wherein the flow valve is provided inside the water heater and adjacent to the heat exchanger.

14. The water heater according to claim 12, wherein the first valve body comprises a first tube body and a bypass tube body, the first flow channel formed inside the first tube body, the first water inlet and the first water outlet respectively provided at two ends of the first tube body, the bypass flow channel formed inside the bypass tube body, one end of the bypass tube body connected to a peripheral wall of the first tube body, and another end of the bypass tube body provided with the bypass port; and
wherein the second valve body comprises a second tube body extending in parallel with the first tube body, the second tube body and the first tube body being spaced apart, the second flow channel formed inside the second tube body, the second water inlet and the second water outlet respectively provided at both ends of the second tube body, the water passage provided at a peripheral wall of the second tube body, and one end of the bypass tube body provided with the bypass port being detachably connected to a portion of the second tube body provided with the water passage.

15. The water heater according to claim 14, wherein the second valve body further comprises an insert sleeve provided at the peripheral wall of the second tube body, the insert sleeve surrounding the water outlet and extending toward the first tube body, and one end of the bypass tube body provided with the bypass port being detachably sealed within the insert sleeve.

16. The water heater according to claim 14, wherein an inner diameter of the first tube body is greater than an inner diameter of the bypass tube body, and a bypass ratio being not less than 42%; and/or,
wherein an area of the water passage is greater than an area of the bypass port.

17. The water heater according to claim 14, wherein the first water inlet and the second water inlet are provided diagonally, wherein the first water outlet and the second water outlet are provided diagonally.

18. The water heater according to claim 14, wherein the first valve body and/or the second valve body is provided with a connection part to be connected and fixed to a back plate of the water heater.

19. The water heater according to claim 18, wherein the first valve body and/or the second valve body are integrally formed with the connection part, and the connection part connected and fixed to the back plate through a connection piece; and/or,
wherein the first valve body, the second valve body, and the connection part are plastic pieces.

20. The water heater according to claim 12,
wherein the flow valve further comprises a flow sensor provided at the first valve body to detect a water inlet flow of the first flow channel; and/or,
wherein the flow valve further comprises a temperature sensor provided at the first valve body to detect an inlet water temperature of the first flow channel; and/or,
wherein the controller is a solenoid valve or a proportional valve.
